(19) United States
(12) Patent Application Publication
(10) Pub. No.: US 2017/0129765 A1
(43) Pub. Date: May 11, 2017

(54) FILLING ADAPTER (AERATION LINE)

(71) Applicant: Dürr Somac GmbH, Stollberg (DE)

(72) Inventors: Thomas ACHATZ, Niederdorf (DE); Eric SELBMANN, Gersdorf (DE); Frank WIELAND, Burkhardtsdorf (DE)

(73) Assignee: DÜRR SOMAC GMBH, Stollberg (DE)

(21) Appl. No.: 15/129,770

(22) PCT Filed: Mar. 18, 2015
(86) PCT No.: PCT/DE2015/000138

§ 371 Date: Sep. 27, 2016

(30) Foreign Application Priority Data
Mar. 29, 2014 (DE) 10 2014 004 824.1

(51) Int. Cl. B67D 7/42; B67D 7/04; B67D 7/02

(52) U.S. Cl. CPC B67D 7/42; B67D 7/0294; B67D 7/04

(57) ABSTRACT

A filling adapter for a container to be filled with media, in particular for the filling of containers on assembly lines for the production of motor vehicles where the filling adapter is equipped with a hose pack, electrical, pneumatic, and hydraulic lines. The filling adapter has a barrel and a ball piece and is operatively connected to two media lines in a hose pack, wherein the media are redistributed in the adapter head, in which a filling valve and a vacuum valve are arranged, which are each connected to the barrel, and wherein an aeration line branches off from a vacuum line in the hose pack by means of a check valve and is connected to the ball piece.

### CROSS-REFERENCE TO RELATED APPLICATIONS

This application is a national Phase of PCT International Application PCT/DE2015/000138 filed on Mar. 18, 2015. This application claims the benefit of and priority to German Patent Application No. 10 2014 004 824.1, filed on Mar. 29, 2014. The entire disclosures of each of the above applications are incorporated herein by reference.

### FIELD

The disclosure relates to a filling adapter for a container to be filled with media (e.g. oils, gases, coolants and the like), in particular for the initial filling of containers with operating substances on assembly lines for the production of motor vehicles, wherein the filling adapter is equipped with a hose pack, electrical, pneumatic and hydraulic lines.

### BACKGROUND

This section provides background information related to the present disclosure which is not necessarily prior art.

Containers must be filled with liquids or gases for numerous technical applications. A typical application in this respect are motor vehicles where housings, circuits, equalizing reservoirs and the like have to be filled with fuel, lubricants, coolants, and other operating substances. In the manufacturing process, these vehicles must be filled, for example, with brake fluid, power steering fluid, coolant, refrigerant, windshield wiper fluid, and fuel. These media are fed via hoses and special adapters to the respective circuits of the vehicles.

To perform the filling, a worker has to bring the adapter and hose pack to the vehicle depending on the respective position of the filling station and connect it to the ports of the circuits to be filled. The hoses typically include multiple lines with different functions for vacuum application, back suction, filling, aerating, as well as for electrical cables. These functions are implemented by special valve interconnections in the adapter head.

In a first variation that is considered to be state of the art, the filling and back suctioning functions are performed by means of a barrel and the vacuum and aeration functions are performed by a ball piece. This variant facilitates a simple switching configuration. In addition, it requires only two valves in the filling adapter and only two media lines in the hose pack. It is a disadvantage, however, that a large cross section has to be pulled twice (1× for filling, 1× for vacuum) into the container to be filled. This inevitably results in a limitation of the potential cross section.

In a second variation that is considered to be state of the art, involves vacuuming, filling and back suctioning functions using a barrel. Only the aeration function is performed by a ball piece. A major advantage of this variant is that the large cross section only has to be pulled once into the container to be filled. This results in a considerable increase of the potential cross section. But the more complex configuration is a disadvantage. It requires three valves in the adapter head and three media lines in the hose pack as well as an additional valve in the system. Regardless of the extra cost, these additional valves are also additional interfering sources for the functioning of the filling station.

Clean Substitute Specification

### SUMMARY

This section provides a general summary of the disclosure, and is not a comprehensive disclosure of its full scope or all of its features.

The purpose of this disclosure is to create a technical solution by means of which the technical and economic advantages of the two known general approaches to a solution can be combined without generating additional disadvantages.

This problem is solved in that the filling adapter comprises a barrel and a ball piece and is operatively connected to two media lines in a hose pack, wherein the media are redistributed in the adapter head, in which a filling valve and a vacuum valve are arranged, which are each connected to the barrel, and wherein an aeration line branches off from a vacuum line in the hose pack by means of a check valve and is connected to the ball piece.

When in operation, the vacuum valve is opened during evacuation and the check valve remains closed. Hence the vacuum is pulled over the barrel. During aeration, however, the aeration pressure is applied to the vacuum line within the hose pack, wherein the vacuum valve remains closed and the check valve is opened. This causes the aeration pressure to flow via the ball piece into the container.

The technical solution according to the disclosure advantageously combines technical and economic advantages of known approaches to a solution while the detailed design proposed was not obvious to a person skilled in the art.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a stylized representation of the fundamental switching configuration of the components.

FIG. 2 shows a cross section of the components that are significant for the present disclosure and their arrangement relative to one another.

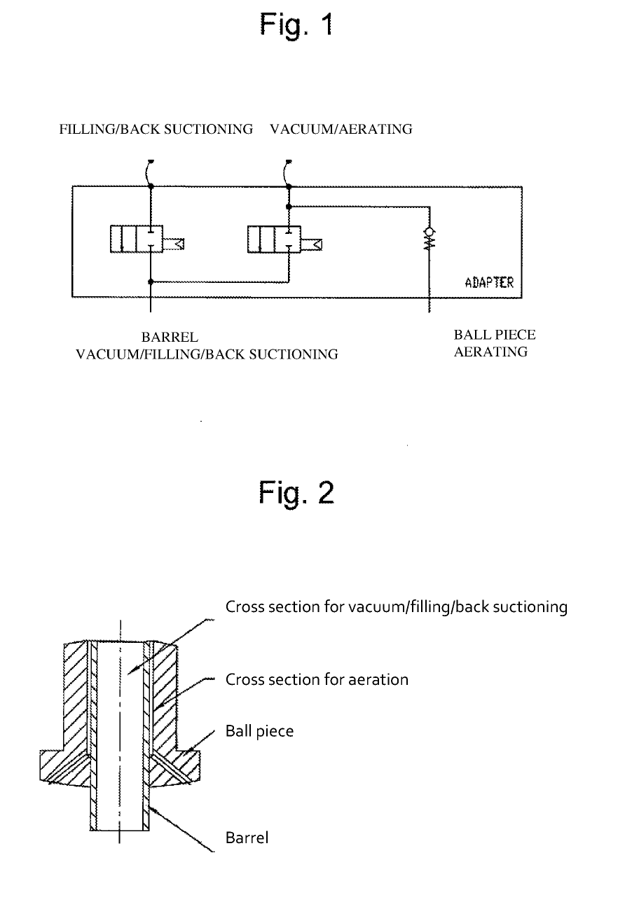

Corresponding reference numerals indicate corresponding parts throughout the several views of the drawings.

### DETAILED DESCRIPTION

Example embodiments will now be described more fully with reference to the accompanying drawings.

The hose pack, which is not shown in detail here, contains two media lines, wherein the media are redistributed in an adapter head. Two valves are mounted in the adapter head, a filling valve and a vacuum valve. These two valves are connected to a barrel. An aeration line branches off from the vacuum line in the hose pack and is connected to a ball piece.

During evacuation, the vacuum valve is opened. The check valve remains closed. The vacuum is pulled over the barrel.

During aeration, the aeration pressure is applied to the vacuum line in the hose pack. The vacuum valve remains closed. The check valve opens. The aeration pressure flows into the container via the ball piece.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A filling adapter for a container to be filled with media, in particular for the initial filling of containers with operating substances on assembly lines for the production of motor vehicles, wherein the filling adapter is equipped with a hose pack, electrical, pneumatic and hydraulic lines, wherein
the filling adapter comprises a barrel and a ball piece and is operatively connected to two media lines in a hose pack, wherein the media are redistributed in the adapter head, in which a filling valve and a vacuum valve are arranged, which are each connected to the barrel, and wherein an aeration line branches off from a vacuum line in the hose pack by means of a check valve and is connected to the ball piece.

2. The filling adapter according to claim 1, wherein
the vacuum valve is opened and the check valve remains closed during evacuation, such that the vacuum is pulled over the barrel.

3. The filling adapter according to claim 1, wherein
the aeration pressure is applied to the vacuum line in the hose pack during aeration, wherein the vacuum valve remains closed and the check valve opens, such that the aeration pressure flows via the ball piece into the container.
